(19) United States
(12) Patent Application Publication
(10) Pub. No.: US 2012/0007981 A1
(43) Pub. Date: Jan. 12, 2012

(54) Passenger surveillance

(76) Inventor: Ernest L. Guerrera, South Easton, MA (US)

(21) Appl. No.: 12/803,937

(22) Filed: Jul. 9, 2010

(51) Int. Cl. H04N 7/18

(52) U.S. Cl. 348/143

(57) ABSTRACT

Methods and apparatus, including computer program products, for passenger surveillance. A system for implementing passenger surveillance includes a control unit, a stationary interface, a portable interface, an Aircraft Communications Addressing and Reporting System (ACARS) unit and one or more cameras. A method for enabling passenger surveillance includes mounting one or more cameras to an interior position of a housing, the one or more cameras linked to a control unit and controlled by a user interface device, the housing including one or more animate or inanimate objects, receiving images of the one or more animate or inanimate objects from the one of more cameras at the user interface device, locking on to an animate or inanimate object of interest, and tracking the animate or inanimate object of interest by controlling the one or more cameras.

### BACKGROUND OF THE INVENTION

The invention generally relates to security, and more specifically to passenger surveillance.

Existing public transportation vehicle security practices tend to focus on one of three things. First, security measures designed to gather intelligence about further incidents, such as hijacking. Second, security measures designed to prevent weapons, explosives or other items that could potentially be used to damage a public transportation vehicle or pose a threat to those on-board the transportation vehicle. Third, security measures designed to concentrate on post-incident investigation using, for example, a cockpit voice recorder (CVR) and flight data recorder (FUR), commonly referred to as the “black box.”

One deficiency of all of these existing security measures is that they do not provide reliable means to quickly identify incidents, such as a hijacking, as they occur and provide decision-makers in remote locations with the information necessary to react appropriately to the incident.

### SUMMARY OF THE INVENTION

The present invention provides methods and apparatus, including computer program products, for passenger surveillance.

In general, in one aspect, the invention features a system for implementing passenger surveillance including a control unit, a stationary interface, a portable interface, an Aircraft Communications Addressing and Reporting System (ACARS) unit and one or more cameras.

In another aspect, the invention features a method for enabling passenger surveillance including mounting one or more cameras to an interior position of a housing, the one or more cameras linked to a control unit and controlled by a user interface device, the housing including one or more animate or inanimate objects, receiving images of the one or more animate or inanimate objects from the one of more cameras at the user interface device, locking on to an animate or inanimate object of interest, and tracking the animate or inanimate object of interest by controlling the one or more cameras.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

Like reference numbers and designations in the various drawings indicate like elements.

### DETAILED DESCRIPTION

Systems and methods of the present invention, sometimes referred to here as the Passenger Surveillance System (PSS), combine camera and communications technologies to enable, among other things, an ability to lock on and track designated targets, assign and pass camera control to various authorized users, and run in both automated and passive operation. Systems and methods of the present invention enable a passive/active surveillance system that can be controlled remotely from on-board controllers, or ground-based consoles by authorized personnel for real-time viewing, camera control and video image storage. The video images can also be transferred to any designated, portable electronic device, such as a laptop or cell phone.

Although the example discussed herein is described for the airline industry, systems and methods of the present invention can be easily deployed for other public transportation applications, such as rail or bus, for example. Further, the system described can be incorporated into existing traffic monitoring systems for the purpose of locking onto a vehicle and tracking it.

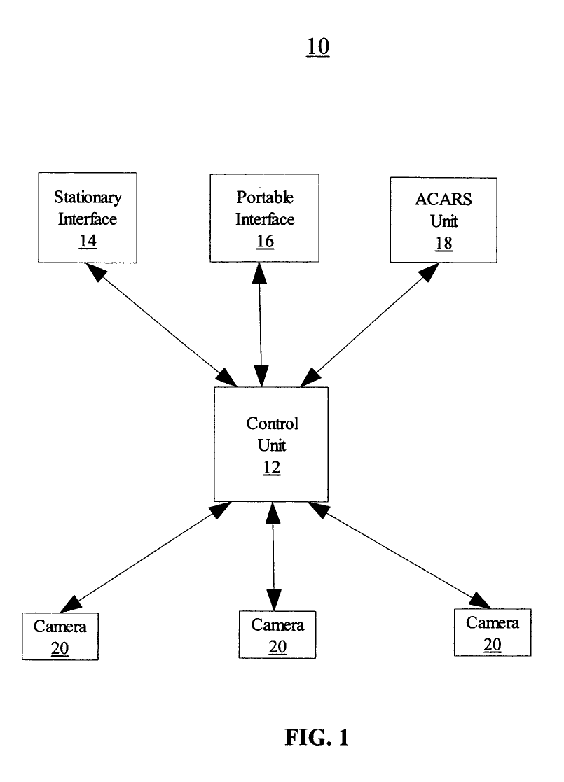

As shown in FIG. 1, a system 10 for implementing passenger surveillance can include a control unit 12, a stationary interface 14, a portable interface 16, an Aircraft Communications Addressing and Reporting System (ACARS) unit 18 and one or more cameras 20.

The control unit 12 may include a dual small form factor personal computer (PC) or rack mountable units configured as an active/passive high availability Linux cluster. The control unit 12 may also include a solid state disk (SSD) network accessible storage (NAS) unit with disaster proof enclosure for image storage, a gigabit Ethernet switch with IEEE 802.11 secure wireless Ethernet, and a Uninterrupted Power Supply (UPS) unit.

The interfaces 14 and 16 enable crew and security personnel to control the system 10, view still video images and streaming video images, and communicate with each other and ground stations using the ACARS unit 18. The interfaces 14 and 16 include an authentication system that restricts use of the interfaces 14, 16 to authorized personnel. The interfaces 14, 16 enable retrieval and viewing of stored historical still and streaming video images, and viewing of live images. This enables a user to manually focus the one or more cameras 20 on any position in the cabin or automatically focus the camera array 20 on a particular seat position or pre-defined cabin position.

More specifically, the stationary interface 14 includes a touch screen device mounted on the cabin wall. The stationary interface 14 is connected to the control unit 12 using, for example, CAT-6 Ethernet cable. In implementations, there can be one or more stationary interfaces 14.

The portable interface 16 can include a laptop personal computer (PC) or hand-held device, such as a smart phone, which can be carried by on-board security personnel. The portable interface 16 is connected to the control unit 12 using IEEE 802.11n secure wireless Ethernet. In implementations, there can be one or more portable interfaces 16.

The Aircraft Communications Addressing and Reporting System (ACARS) unit 18 enables the sending and receiving of ACARS messages to and from ground stations on behalf of users. This may include emergency situation reports and free text messages.

In general, ACARS is a digital data link system for transmission of short, relatively simple messages between aircraft and ground stations via radio or satellite. The protocol, which was designed by ARINC to replace their VHF voice service and deployed in 1978, uses telex formats. SITA later augmented their worldwide ground data network by adding radio stations to provide ACARS service. Over the next 20 years, ACARS will be superseded by the Aeronautical Telecommunications Network (ATN) protocol for Air Traffic Control communications and by the Internet Protocol for airline communications.

The one or more cameras 20, also referred to as a camera array, are security cameras mounted on an aircraft cabin ceiling in such a way that the entire cabin space can be monitored. The camera array 20 includes multiple Internet Protocol (IP) network cameras with remotely controllable motorized pan/tilt/zoom head. The camera array 20 is linked to the control unit 12 using shielded/fireproof CAT-6 Ethernet cable. The camera array 20 is powered supplied by Power over Ethernet (PoE) technology.

In general, PoE technology describes a system to safely pass electrical power, along with data, on Ethernet cabling. PoE typically requires category 5 cable or higher for high power levels, but can operate with category 3 cable for low power levels. Power can come from a power supply within a PoE-enabled networking device such as an Ethernet switch or from a device built for “injecting” power onto the Ethernet cabling, dubbed midspan.

In one specific implementation, the system 10 utilizes two types of cameras, i.e., pin-hole and PTZ (Pan/Tilt/Zoom), strategically located throughout a passenger cabin so that all seat positions and movements throughout the cabin can be monitored. At a start of a boarding process, the system 10 is activated, either manually or automatically, and image recording continues throughout the duration of the flight and disembarkation.

In the event of any suspicious or questionable passenger behavior on-board the aircraft, any authorized crew member can monitor specific areas of the cabin using the stationary interfaces 14 and/or portable interface 16

PTZ cameras can be automatically aimed to a specified seat location or follow the movements of a designated individual. Multiple seat locations and/or individuals can be designated capture targets.

Images from the camera array 20 are continuously stored in the control unit 20. The stored still or real time images can be accessed from any stationary interface 14 located in crew service areas or cockpit. On-board air marshals or other security personnel may access the system 10 using the portable interface 16. The ACARS unit 18 enables ground stations to interface with the system 10 and provides a vehicle for the transmission of alert messages to a Federal Aviation Administration (FAA) control center and/or to other designated ground-based systems.

All components of the system 10 include field replaceable units using standardized interconnect harnesses for simplified maintenance. Camera placement and cabin configuration is flexible to accommodate the multitude of aircraft models available from different manufacturers.

The combination of fixed pin-hole cameras concentrated on specific seat rows or cabin sections and PTZ cameras along the aisles may be deployed for optimum coverage of the passenger compartment.

The system 10 operates in a passive-active mode with either automatic activation based on signals from aircraft door sensors, or manual activation from any interface 14, 16.

Images are stored on redundant storage in disaster proof enclosures.

PTZ cameras can be automatically aimed at specified seat location or multiple seat locations. PTZ cameras can be set to follow the movements of a designated passenger of interest, or multiple passengers. The camera array 20 can be controlled from any interface 14, 16.

Assignment of control over the system 10 can be based on priority level of individual users with override capability in the event of an emergency situation.

All fixed-mounted components are hardened to be tamper resistant and shock resistant and all system components are dual powered and fault tolerant.

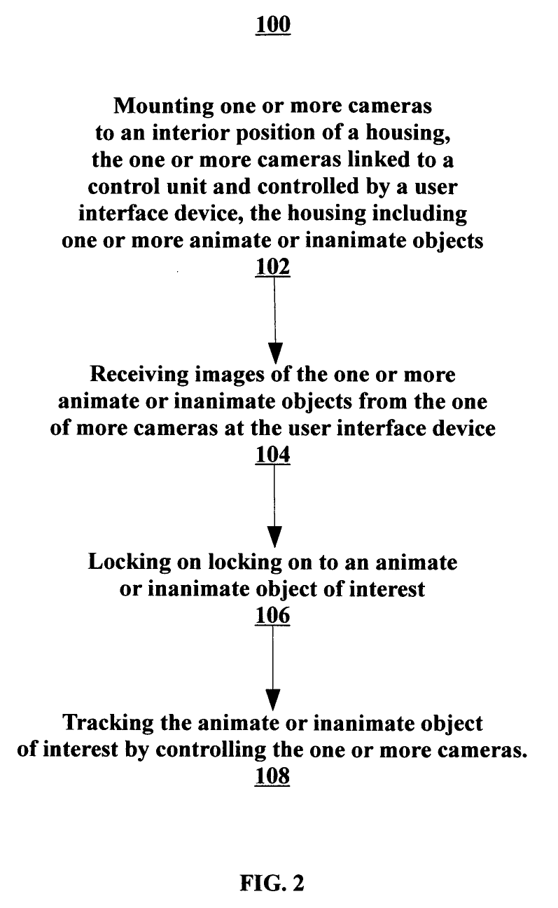

As shown in FIG. 2, a passenger surveillance process 100 includes mounting (102) one or more cameras to an interior position of a housing, the one or more cameras linked to a control unit and controlled by a user interface device, the housing including one or more animate or inanimate objects.

The one or more cameras can be multiple Internet Protocol (IP) network cameras with remotely controllable motorized pan/tilt/zoom head.

The control unit can be a dual small form factor personal computer (PC) or a rack mountable computing unit configured as an active/passive high availability Linux cluster. The control unit can include a solid state disk (SSD) network accessible storage (NAS) unit with disaster proof enclosure for image storage, a gigabit Ethernet switch with IEEE 802.11 secure wireless Ethernet, and a Uninterrupted Power Supply (UPS) unit.

In implementations, connections throughout the system 10 can wired, wireless or a combination of wired and wireless. Further, the system 10 supports Short Message Service (SMS) messaging between remote, portable and stationary interfaces. In general, SMS is the text communication service component of phone or mobile communication systems, using standardized communications protocols that allow the exchange of short text messages between fixed line or mobile phone devices.

The user interface device can be a stationary interface and/or a hand-held portable interface.

The user interface device enables communication with a ground station using an Aircraft Communications Addressing and Reporting System (ACARS) unit linked to the control unit.

Process 100 receives (104) images of the one or more animate or inanimate objects from the one of more cameras at the user interface device. The received images of the one or more animate or inanimate objects are stored in an image repository associated with the control unit.

Process 100 locks on (106) to an animate or inanimate object of interest. The control unit can include facial recognition software.

Process 100 tracks (108) the animate or inanimate object of interest by controlling the one or more cameras.

Embodiments of the invention can be implemented in digital electronic circuitry, or in computer hardware, firmware, software, or in combinations of them. Embodiments of the invention can be implemented as a computer program product, i.e., a computer program tangibly embodied in an information carrier, e.g., in a machine readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand alone program or as a module, component, subroutine, or other unit suitable for use in a computing environment. A computer program can be deployed to be executed on one computer or on multiple computers at one site or distributed across multiple sites and interconnected by a communication network.

Method steps of embodiments of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in special purpose logic circuitry.

It is to be understood that the foregoing description is intended to illustrate and not to limit the scope of the invention, which is defined by the scope of the appended claims. Other embodiments are within the scope of the following claims.

What is claimed is:

1. A system comprising:
a control unit having at least one of a stationary interface or portable interface;
one or more cameras linked to the control unit; and
an Aircraft Communications Addressing and Reporting System (ACARS) unit linked to the control unit.

2. The system of claim 1 wherein the control unit is a dual small form factor personal computer (PC).

3. The system of claim 1 wherein the control unit is a rack mountable computing unit configured as an active/passive high availability Linux cluster.

4. The system of claim 2 wherein the control unit further comprises
a solid state disk (SSD) network accessible storage (NAS) unit with disaster proof enclosure for image storage;
a gigabit Ethernet switch with IEEE 802.11 secure wireless Ethernet; and
a Uninterrupted Power Supply (UPS) unit.

5. The system of claim 1 wherein the at least one of the stationary interface or the portable interface enable a user to control the control unit, view video images from the one or more cameras, and communicate with a ground station using the ACARS unit.

6. The system of claim 1 wherein the at least one of the stationary interface or the portable interface includes an authentication system.

7. The system of claim 1 wherein the stationary interface is connected to the control unit with CAT-6 Ethernet cable.

8. The system of claim 1 wherein the portable interface is one of a laptop personal computer (PC) or hand-held device.

9. The system of claim 1 wherein the portable interface is linked to the control unit using IEEE 802.11n secure wireless Ethernet.

10. The system of claim 10 wherein the one or more cameras are multiple Internet Protocol (IP) network cameras with remotely controllable motorized pan/tilt/zoom head, mounted on an anterior ceiling of a cabin area.

11. The system of claim 1 wherein the one or more cameras are linked to the control unit 12 using shielded/fireproof CAT-6 Ethernet cable and powered by Power over Ethernet (PoE).

12. A method comprising:
mounting one or more cameras to an interior position of a housing, the one or more cameras linked to a control unit and controlled by a user interface device, the housing including one or more animate or inanimate objects;
receiving images of the one or more animate or inanimate objects from the one of more cameras at the user interface device;
locking on to an animate or inanimate object of interest; and
tracking the animate or inanimate object of interest by controlling the one or more cameras.

13. The method of claim 12 wherein the one or more cameras are multiple Internet Protocol (IP) network cameras with remotely controllable motorized pan/tilt/zoom head

14. The method of claim 12 wherein control unit is a dual small form factor personal computer (PC) or a rack mountable computing unit configured as an active/passive high availability Linux cluster.

15. The method of claim 14 wherein control unit further comprises:
a solid state disk (SSD) network accessible storage (NAS) unit with disaster proof enclosure for image storage;
a gigabit Ethernet switch with IEEE 802.11 secure wireless Ethernet; and
a Uninterrupted Power Supply (UPS) unit.

16. The method of claim 12 wherein the user interface device enables communication with a ground station using an Aircraft Communications Addressing and Reporting System (ACARS) unit linked to the control unit.

17. The method of claim 12 wherein the received images of the one or more animate or inanimate objects are stored in an image repository.

18. The method of claim 12 wherein the control unit includes facial recognition software.

19. The method of claim 12 wherein the user interface device is selected from the group of a stationary interface and a hand-held portable interface.
